(19) United States
(12) Patent Application Publication
(10) Pub. No.: US 2014/0035268 A1
(43) Pub. Date: Feb. 6, 2014

(54) LAP PRETENSIONER AND SEATBELT APPARATUS

(71) Applicant: Hirokazu NAGANUMA, Tokyo (JP)

(72) Inventor: Hirokazu NAGANUMA, Tokyo (JP)

(73) Assignee: Takata Corporation, Tokyo (JP)

(21) Appl. No.: 13/950,501

(22) Filed: Jul. 25, 2013

(30) Foreign Application Priority Data
Jul. 31, 2012 (JP) 2012-170552

(51) Int. Cl. B60R 22/195

(52) U.S. Cl. CPC B60R 22/195
USPC 280/807; 242/389

(57) ABSTRACT

A lap pretensioner includes a wire to be connected to a belt, a sleeve-shaped cover covering the wire, an actuator configured to pull the wire to pull the belt, and a limiting member configured to limit a displacement of the cover, the limiting member extending inside the cover in a longitudinal direction of the cover.

### BACKGROUND OF THE INVENTION

1. Field of the Invention

The disclosures herein relate to a pretensioner provided with a cover for covering a wire connected to a belt, and a seatbelt apparatus having the pretensioner.

2. Description of the Related Art

Patent Document 1 discloses a technology relating to a pretensioner provided with a cover for covering a wire connected to a belt. Patent Documents 2 and 3 disclose a technology relating to a structure by which a lap pretensioner is installed on a vehicle.

A belt and a wire connected to the belt are pulled taut by a retracting force of a retractor even when the lap pretensioner is not in an operating state. Upon the belt and the wire being pulled taut, the position of the cover covering the wire moves with the wire. Such a moved cover may act as an obstruction depending on the shape of the vehicle or inner space thereof in which the lap pretensioner is installed.

FIG. 1 is a drawing illustrating a first example of a pretensioner 130 in which a lap belt 111a of a belt 111 for a front seat is pulled taut. The view is taken from the inner side of a vehicle interior space toward the lateral side of the vehicle. In this state, a tubular cover (i.e., boot 140) covering a wire 133 connected to the lap belt 111a is situated close to a vehicle door space edge 150 that defines a door space 151, in which a rear door (not shown) is situated. When the belt 111 is pulled upward by a retracting force of a retractor (not shown), the boot 140 blocks part of the door space 151 on the anterior side of the vehicle.

FIG. 2 is a drawing illustrating a second example of a pretensioner 130. In FIG. 2, a back 118b of a front seat 118 is viewed from the rear-seat side. In this state, a trim 119 of a center pillar (i.e., B pillar) is slanted toward the inner side of the vehicle, so that a shoulder anchor (not shown) attached at the top of the trim 119 is situated toward the center of the vehicle. When the belt 111 is pulled upward by a retracting force of a retractor (not shown) situated near the bottom of the trim 119, the boot 140 that is originally situated between the trim 119 and the lateral face 118a of the front seat 118 may easily move to a position behind the back 118b of the front seat 118.

The disclosures herein provide a pretensioner that prevents a cover for covering a wire connected to a belt from being easily moved, and a seat belt apparatus having such a pretensioner.

### [Patent Document]

[Patent Document 1] Japanese Patent Application Publication No. 2010-58703
[Patent Document 2] Japanese Patent Application Publication No. 2006-199197
[Patent Document 3] Japanese Patent Application Publication No. 2009-83689

### SUMMARY OF THE INVENTION

According to an embodiment, a lap pretensioner includes a wire to be connected to a belt, a sleeve-shaped cover covering the wire, an actuator configured to pull the wire to pull the belt, and a limiting member configured to limit a displacement of the cover, the limiting member extending inside the cover in a longitudinal direction of the cover.

According to an embodiment, a seat belt apparatus includes a lap pretensioner, a belt, a retractor configured to retract the belt, a tongue attached to the belt, and a buckle to which the tongue is detachably attached, wherein the lap pretensioner includes a wire to be connected to the belt, a sleeve-shaped cover covering the wire, an actuator configured to pull the wire to pull the belt, and a limiting member configured to limit a displacement of the cover, the limiting member extending inside the cover in a longitudinal direction of the cover.

According to at least one embodiment, a cover covering a wire connected to a belt is prevented from being easily moved.

### BRIEF DESCRIPTION OF THE DRAWINGS

Other objects and further features of the present invention will be apparent from the following detailed description when read in conjunction with the accompanying drawings, in which:

FIG. 1 is a drawing illustrating an example of a lap pretensioner;

FIG. 2 is a drawing illustrating an example of a lap pretensioner;

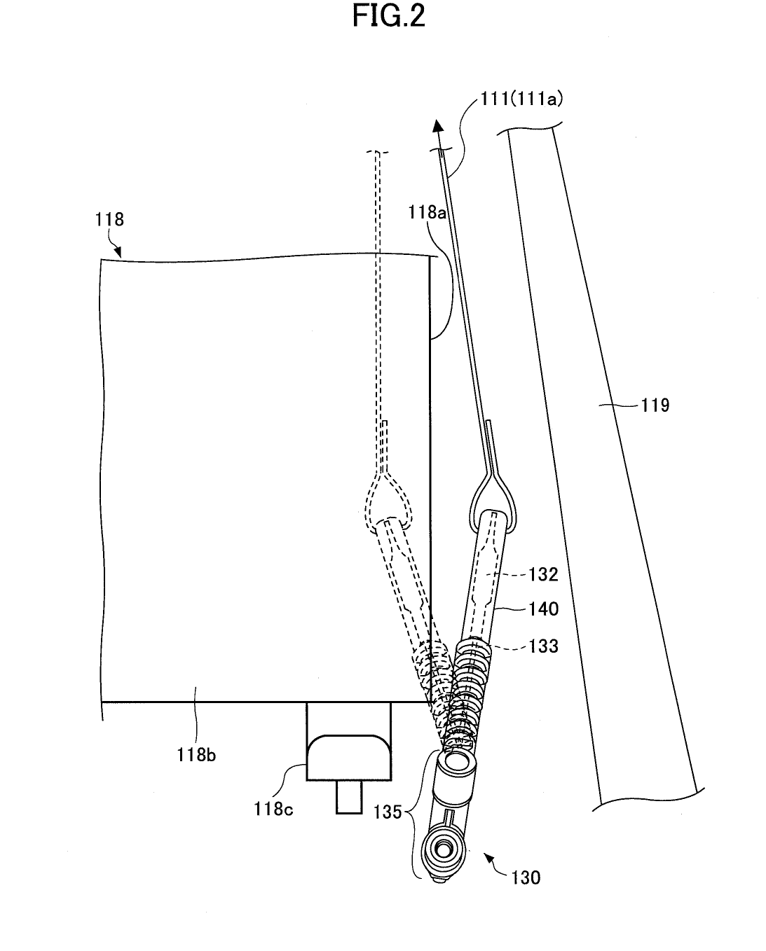

FIG. 3 is a drawing illustrating a seatbelt apparatus;

FIG. 4 is a lateral view of a lap pretensioner according to an embodiment;

FIG. 5 is a lateral view of the lap pretensioner of FIG. 4 viewed from the opposite side;

FIG. 6 is a lateral view of the lap pretensioner of FIG. 4 viewed from above; and

FIG. 7 is a drawing illustrating an example of a limiting member for limiting a displacement of a sleeve-shaped cover.

### DESCRIPTION OF THE PREFERRED EMBODIMENTS

In the following, embodiments of the present invention will be described with reference to the accompanying drawings.

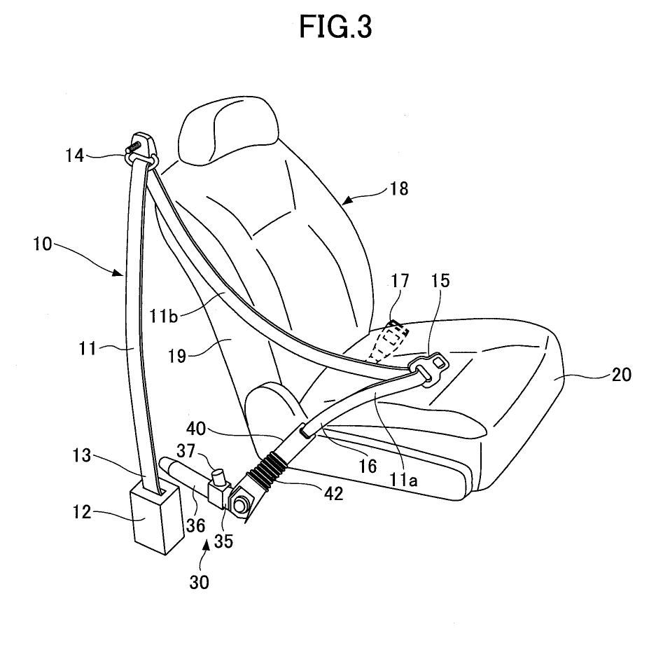

FIG. 3 is a drawing illustrating a seat belt apparatus according to an embodiment. In FIG. 3, a seat belt apparatus 10 as mounted in a vehicle is illustrated. The seat belt apparatus 10 includes a belt 11, a retractor 12, a tongue 15, a buckle 17, and a pretensioner 30.

The belt 11 is a strip-shaped member for holding a passenger in a seat 18. One end 13 of the belt 11 is connected to the retractor 12, and the other end 16 of the belt 11 is connected to the pretensioner 30. The belt 11 is also referred to as webbing.

The retractor 12 is a device that allows the belt 11 to be retracted or extracted. Upon detecting deceleration exceeding a predetermined value at the time of vehicle collision or the like, for example, the retractor 12 restrains the belt 11 from being extracted. The retractor 12 may be fixedly mounted on the vehicle body at the side of a back 19 of the seat 18 (e.g., mounted on a lower portion of a pillar on which an anchor 14 is fixedly mounted).

The tongue 15 is a plate-shape member slidably attached to the belt 11 between the pretensioner 30 and the shoulder anchor 14.

The buckle 17 is a member to which the tongue 15 is detachably attached. The buckle 17 is fixedly mounted on the vehicle body on the opposite side of a seat bottom 20 from the retractor 12.

With the tongue 15 attached to the buckle 17, a shoulder belt portion 11b of the belt 11 holds the chest of a passenger in the seat 18, and a lap belt portion 11a of the belt 11 holds the waist portion of the passenger. The shoulder belt portion 11b is a portion of the belt 11 located between the shoulder anchor 14 and the tongue 15. The lap belt portion 11a is a portion of the belt 11 located between the tongue 15 and the pretensioner 30.

The pretensioner 30 is a lap pretensioner having a pretensioner actuator 35 that promptly retracts the lap belt portion 11a of the belt 11 upon detecting deceleration exceeding a predetermined value at the time of vehicle collision or the like, thereby tightening up any slack in the lap belt portion 11a relative to the passenger's waist portion. The pretensioner actuator 35 may typically be mounted on the vehicle body at a position close to a door at the side of the seat bottom 20. The pretensioner actuator 35 includes a cylinder 36 having a longitudinal direction thereof aligned with the front-back direction of the vehicle and a gas generator 37 to inject gas into the cylinder 36.

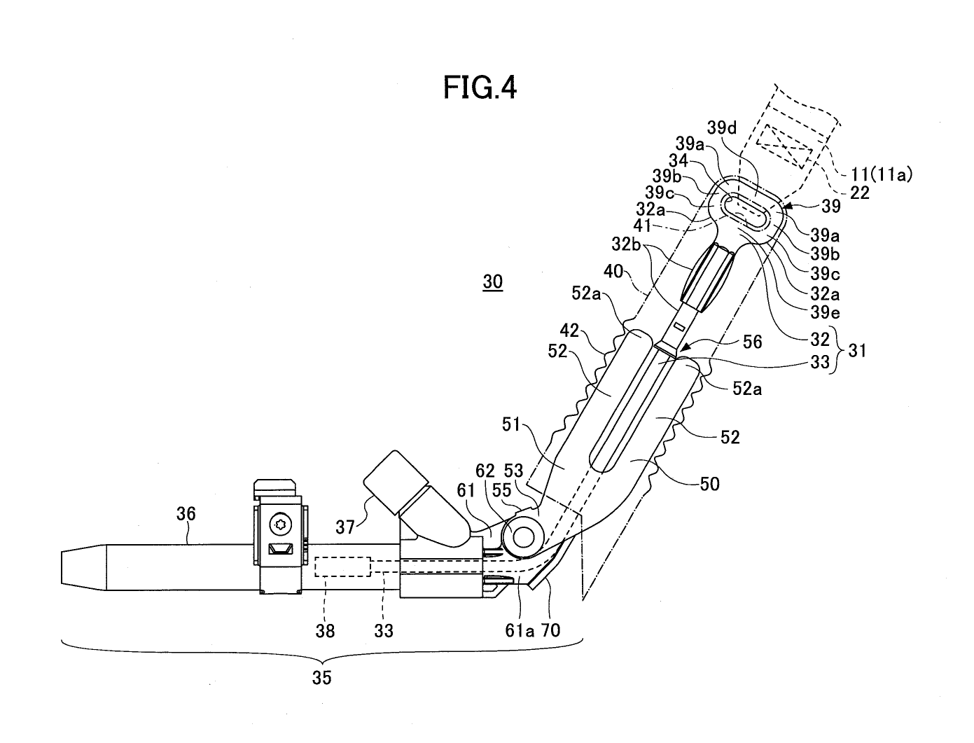

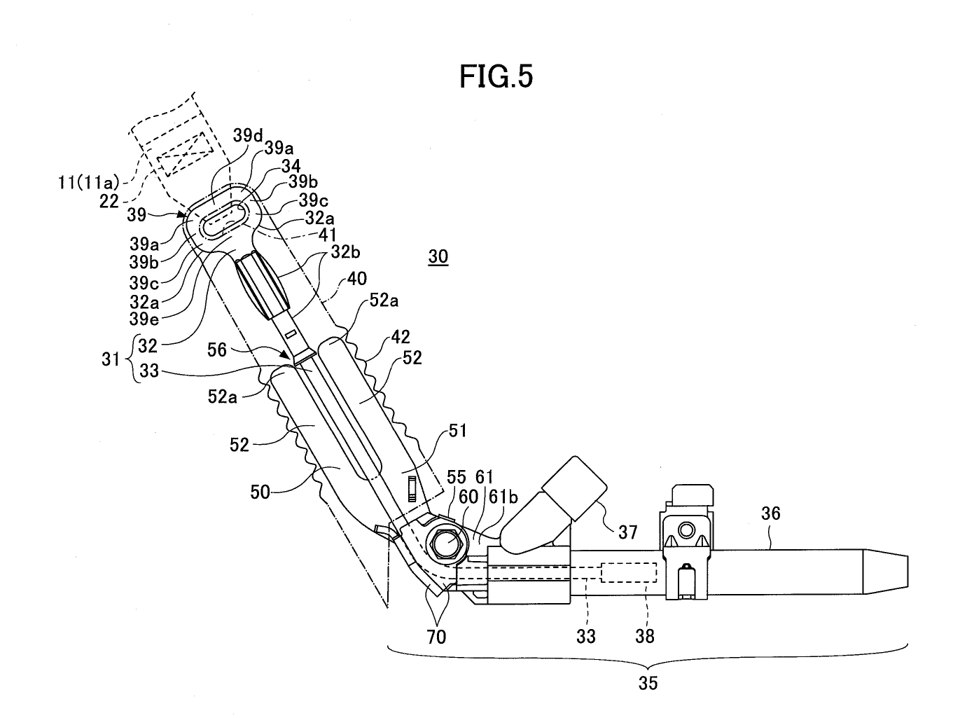

FIG. 4 is a lateral view of one side of the pretensioner 30. FIG. 5 is a lateral view of the other side of the pretensioner 30.

The gas generator 37 injects gas into the cylinder 36 upon detection of deceleration exceeding a predetermined value. As a result of the gas injection into the cylinder 36, a piston 38 moves in the cylinder 36. The piston 38 is connected to the lap belt portion 11a of the belt 11 via a connecting member 31. As a result of the movement of the piston 38 in the cylinder 36, the lap belt portion 11a is pulled by the connecting member 31 toward the pretensioner actuator 35. This results in an increase in the force holding the passenger.

The connecting member 31 includes a ferrule 32, which is a member having a hole 34. The connecting member 31 further includes a wire 33 for providing a connection between the ferrule 32 and the piston 38.

The ferrule 32 is a plate-shape joint for connecting the lap belt portion 11a to the wire 33. The ferrule 32 is also referred to as a lap anchor. The ferrule 32 includes an annular portion 39, a narrowing portion 32a, and a connecting portion 32b. The annular portion 39 has a hole at the center thereof through which the lap belt portion 11a is passed and folded back. The narrowing portion 32a has a width thereof becoming narrower than the width of the annular portion 39. The connecting portion 32b connects the narrowed end of the narrowing portion 32a to the wire 33.

The annular portion 39 has a frame shape that surrounds the hole 34. The annular portion 39 includes an upper side portion 39d, upper corner portions 39a, a lower side portion 39e, lower corner portions 39c, and lateral side portions 39b. The upper side portion 39d is situated on an upper side of the hole 34. The upper corner portions 39a are situated at opposite ends of the upper side portion 39d. The lower side portion 39e is situated on a lower side of the hole 34. The lower corner portions 39c are situated at both ends of the lower side portion 39e. The lateral side portions 39b are situated between the upper corner portions 39a and the lower corner portions 39c, respectively.

The narrowing portion 32a is formed as a structure seamlessly continuing from the lower corner portions 39c of the annular portion 39 to the connecting portion 32b such that the width thereof gradually narrows to form smooth curves. The width of the narrowing portion 32a becomes thinner toward the connecting portion 32b. The rate at which the width of the narrowing portion 32a narrows decreases toward the connecting portion 32b. The narrowing portion 32a may include a portion at which the width thereof widens after some narrowing, or may have no such a portion. The narrowing portion 32a illustrated in FIG. 4 does not have such a portion at which the width thereof widens after some narrowing.

The connecting portion 32b extends toward the pretensioner actuator 35 from the narrowing portion 32a at the position at which the width of the narrowing portion 32a is the narrowest. The width of the connecting portion 32b or the portion at which the width of the narrowing portion 32a is the narrowest is narrower than the width of the annular portion 39. The ratio may be 1 to 3 through 1 to 3.5, and may be selected as appropriate. The connecting portion 32b may connect the lower end of the narrowing portion 32a to an end of the wire 33 by swaging or by use of any other coupling method.

The connecting member 31 is covered with a boot 40 so that the connecting member 31 is not directly visible. Part or all of the boot 40 may be a sleeve-shaped (i.e., tube-shaped) cover. The cover may preferably be a rectangular sleeve shape, or may be some other shape. With the boot 40 covering the connecting member 31, the connecting member 31 is hidden inside the boot 40, which serves to provide a better appearance. Further, such a configuration also serves to prevent the generation of unfamiliar sound that may occur when the connecting member 31 comes in contact with other vehicle interior parts.

The boot 40 may be formed by blow molding. The boot 40 is put on the connecting member 31 from the top of the ferrule 32. The boot 40 has a pair of openings 41 formed at the same position as the hole 34 of the ferrule 32 in the state in which the boot 40 is put on the ferrule 32. The openings 41 are formed at the opposite side faces of the boot 40, respectively.

With this arrangement, putting the boot 40 on the ferrule 32 results in a belt insertion pass being created through one of the openings 41, the hole 34, and the other one of the openings 41. A worker or assembling apparatus may put one end of the belt 11 through one of the openings 41 and then through the hole 34, and pull the end out through the other one of the openings 41, thereby easily passing the end of the belt 11 through the hole 34 and the openings 41.

The end of the belt 11 having passed through the hole 34 and the openings 41 is folded back toward the direction away from the pretensioner actuator 35. The end of the belt 11 that is folded back is stitched with a string 22 on a portion of the belt 11 that is not passed through the hole 34 and the openings 41. With this, the task of attaching the belt 11 is completed.

The boot 40 has an accordion portion (i.e., bellows) 42. When the wire 33 of the connecting member 31 is retracted by the pretensioner actuator 35, the accordion portion 42 may be compressed to allow the wire 33 to be smoothly retracted by the pretensioner actuator 35, thereby allowing the lap belt portion 11a connected to the wire 33 through the ferrule 32 to be smoothly retracted.

The boot 40 may be formed of resin material. A rubber member may be an appropriate material for the boot 40. Olefinic thermoplastic elastomer, for example, may be used as a preferred material.

The pretensioner 30 has a reinforcement plate 50 serving as a limiting member for limiting the displacement of the boot 40 that could be caused by an external force applied to the belt 11 in a non-operating state in which the pretensioner actuator 35 is not pulling the wire 33. The external force applied to the belt 11 in the non-operating state of the pretensioner 30 may be a retracting force of the retractor 12 that is illustrated in FIG. 3. The reinforcement plate 50 extends inside the boot 40 in the longitudinal direction of the boot 40.

Even when an external force is applied to the belt 11 in the non-operating state of the pretensioner 30, the reinforcement plate 50 can prevent the boot 40 covering the wire 33 connected to the belt 11 through the ferrule 32 from being easily displaced together with the wire 33. Since part or all of the reinforcement plate 50 is contained inside and obscured by the boot 40, the reinforcement plate 50 can prevent an unnecessary displacement of the boot 40 without undermining the aesthetic appearance. When the pretensioner 30 actually operates, the displacement of the boot 40 does not have to be limited by a limiting member such as the reinforcement plate 50. This is obvious from the viewpoint of passenger safety.

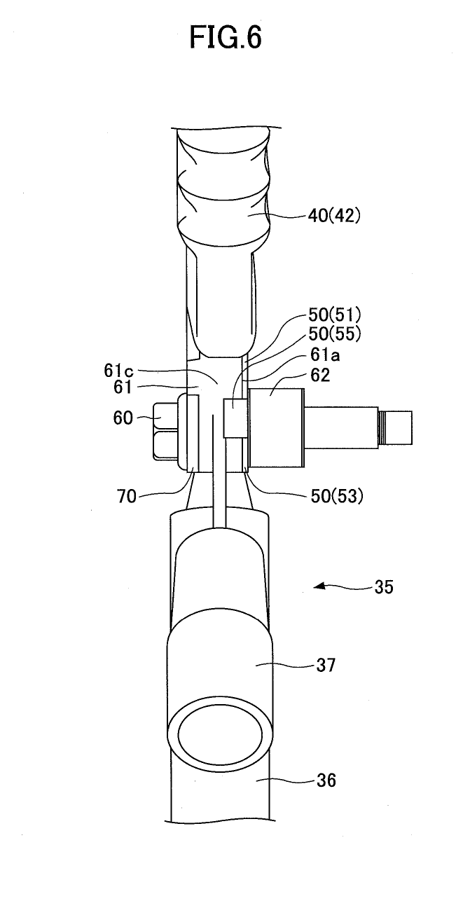

The reinforcement plate 50 is attached to a side face 61a of a guide attachment unit 61 that is one end of the pretensioner actuator 35 in the longitudinal direction thereof (see FIG. 4 and FIG. 6). The pretensioner actuator 35 is fixedly mounted to a vehicle, so that the reinforcement plate 50 attached to the pretensioner actuator 35 is fixedly positioned relative to the vehicle. Further, since the reinforcement plate 50 is attached to the pretensioner actuator 35, the reinforcement plate 50 is easily prevented from being slanted relative to the pretensioner actuator 35.

In FIG. 4 and FIG. 5, upon application of an external force to the belt 11 in the non-operating state of the pretensioner 30, a force is applied to the flexible wire 33 connected to the belt 11 such as to change the direction in which the wire 33 extends from the pretensioner actuator 35 around the pivot point that is at the guide attachment unit 61 of the pretensioner actuator 35. Similarly, upon application of an external force to the belt 11 in the non-operating state of the pretensioner 30, a force is applied to the boot 40 connected to the belt 11 at the openings 41 such as to change the position and orientation of the boot 40.

Since the reinforcement plate 50 inside the boot 40 is attached to the pretensioner actuator 35, an inner surface of the boot 40 comes in contact with the reinforcement plate 50 upon application of the force that attempts to change the position and orientation of the boot 40. This prevents the boot 40 from being easily moved relative to the pretensioner actuator 35. As a result, the belt 11 connected to the boot 40 at the openings 41 does not also move. This prevents a change from easily occurring in the direction in which the wire 33 connected to the belt 11 via the ferrule 32 extends from the guide attachment unit 61.

The reinforcement plate 50 is fixedly attached to the side face 61a of the guide attachment unit 61 in a non-operating state in which the pretensioner actuator 35 is not pulling the wire 33. For example, the reinforcement plate 50 may be secured by a nut 62 to the side face 61a (see FIG. 4) of the guide attachment unit 61 by use of a bolt 60 that is inserted into a hole from the opposite side face 61b (see FIG. 5) of the guide attachment unit 61. As is illustrated, further, the reinforcement plate 50 may be secured to the guide attachment unit 61 by the bolt 60 and the nut 62 together with a wire guide unit 70 disposed on the side face 61b.

The wire guide unit 70 is attached to the guide attachment unit 61, and serves as a wire deflecting member for changing the direction of the wire 33 relative to the longitudinal direction of the pretensioner actuator 35. The wire 33 extends through a gap between the guide attachment unit 61 and the wire guide unit 70 so that a change is made in the direction in which the wire 33 extends from the pretensioner actuator 35.

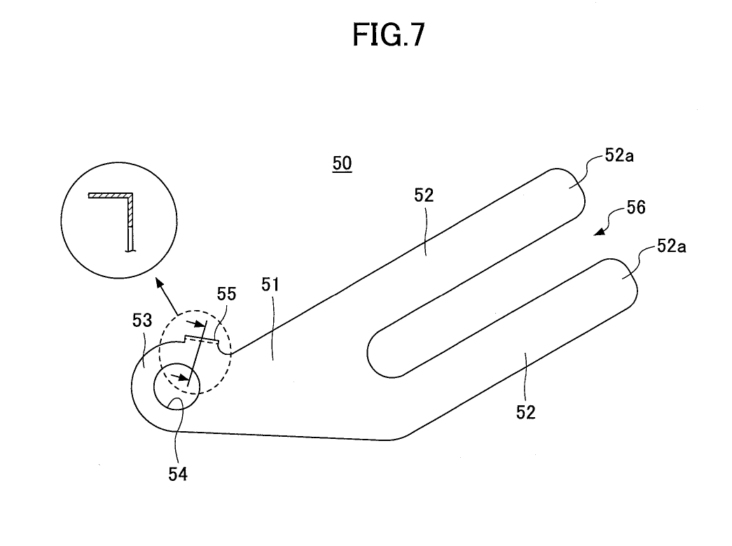

FIG. 7 is a front view of the reinforcement plate 50. The reinforcement plate 50 is a plate-shape member. Due to its plate-shape flatness, the reinforcement plate 50 does not interfere with the action to pull the wire 33 and the ferrule 32. The reinforcement plate 50 includes a base part 51, a pair of extending parts 52 extending in parallel in the same direction from the base part 51, and an attachment part 53 situated on the opposite side of the base part 51 from the extending parts 52. The attachment part 53 includes an attachment hole 54 for attaching the reinforcement plate 50 to the pretensioner actuator 35 of the pretensioner 30, and also includes a projecting part 55 projecting from the attachment part 53. The bolt 60 previously described is inserted through the attachment hole 54.

The reinforcement plate 50 has the projecting part 55 that serves as a rotation limiting member for limiting the rotation of the reinforcement plate 50 around the position at which the reinforcement plate 50 is attached to the pretensioner actuator 35 (i.e., around the position at which the attachment hole 54 of the attachment part 53 is in contact with the guide attachment unit 61). As illustrated in FIG. 6, the projecting part 55 is bent at its base to come in contact with a top face 61c of the guide attachment unit 61 of the pretensioner actuator 35, thereby serving as a stopper to stop the rotation of the reinforcement plate 50. With this arrangement, the reinforcement plate 50 is prevented from easily rotating relative to the guide attachment unit 61 even when the belt 11 is pulled hard or when the boot 40 is pushed hard. As a result, the boot 40 covering the reinforcement plate 50 can be prevented from easily rotating.

As illustrated in FIG. 4, FIG. 5, and FIG. 7, the reinforcement plate 50 is a U-letter-shaped member having a cut 56, which extends in the direction in which the ferrule 32 moves (i.e., the direction in which the boot 40 extends). The provision of the cut 56 ensures that the wire 33 and the ferrule 32 are smoothly pulled. The cut 56 is a void that is situated between the pair of extending parts 52.

It is preferable for the cut 56 to be formed such that the connecting portion 32b that is an end of the ferrule 32 toward the wire 33 is not obstructed. The connecting portion 32b may be situated closer to the pretensioner actuator 35 than are the ends 52a of the extending parts 52 towards the belt 11, such that the connecting portion 32b is positioned inside the cut 56 in a non-operating state in which the pretensioner actuator 35 is not pulling the wire 33. This arrangement can prevent the connecting portion 32b of the ferrule 32 from colliding with the ends 52a when the pretensioner actuator 35 pulls the wire 33.

Although a pretensioner and a seatbelt apparatus having the pretensioner have been described by referring to one or more embodiments, the present invention is not limited to these embodiments. Various modifications and improvements such as combining an embodiment partially or entirely with one or more other embodiments or replacing part of an embodiment with part of another embodiment may be made without departing from the scope of the present invention.

For example, the reinforcement plate 50 having a plate shape was described as a limiting member for limiting the displacement of the cover in the above-described embodiments. However, the limiting member is not limited to such a plate-shaped member.

The disclosed embodiments may be applicable to a seat that is not a front seat if such application is viable.

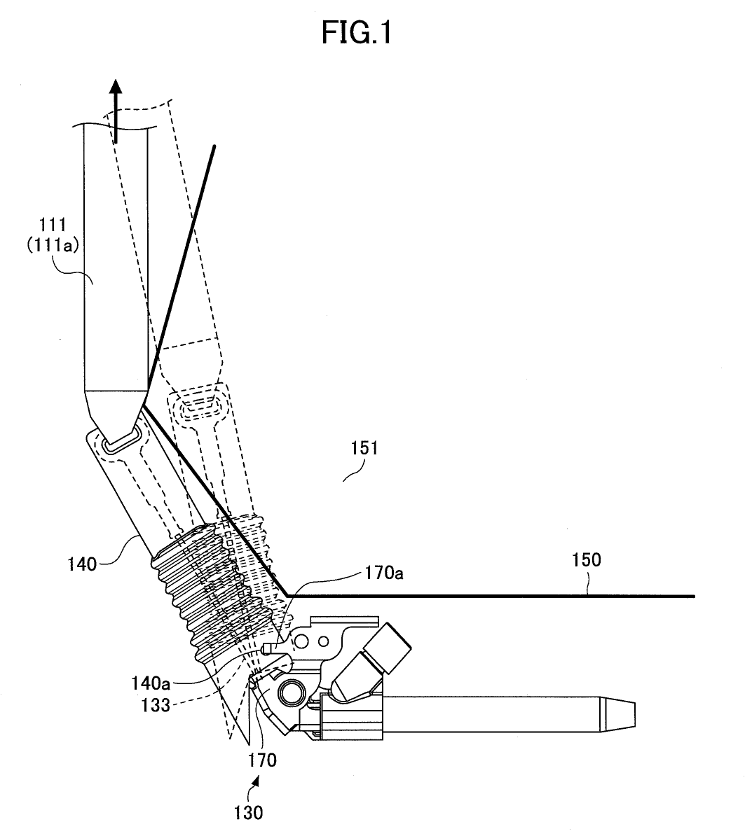

In FIG. 1, a draping preventing unit 170a formed integrally with a wire-guide unit 170 is hooked to a hole 140a formed at the bottom of the boot 140. The same or similar structure may be provided for the boot 40 and the wire guide unit 70 illustrated in FIG. 3 and the like.

The present application is based on Japanese priority application No. 2012-170552 filed on Jul. 31, 2012, with the Japanese Patent Office, the entire contents of which are hereby incorporated by reference.

What is claimed is:

1. A lap pretensioner, comprising:
a wire to be connected to a belt;
a sleeve-shaped cover covering the wire;
an actuator configured to pull the wire to pull the belt; and
a limiting member configured to limit a displacement of the cover, the limiting member extending inside the cover in a longitudinal direction of the cover.

2. The lap pretensioner as claimed in claim 1, wherein the limiting member is mounted on the actuator.

3. The lap pretensioner as claimed in claim 2, wherein the limiting member includes a rotation limiting unit configured to limit rotation of the limiting member around a position at which the limiting member is mounted on the actuator.

4. The lap pretensioner as claimed in claim 1, wherein the limiting member is a plate-shaped member.

5. The lap pretensioner as claimed in claim 1, further comprising a joint configured to connect the belt to the wire, wherein the limiting member has a cut extending in a direction in which the joint moves.

6. The lap pretensioner as claimed in claim 5, wherein an end of the joint toward the wire is situated inside the cut.

7. A seat belt apparatus, comprising:
a lap pretensioner;
a belt;
a retractor configured to retract the belt;
a tongue attached to the belt; and
a buckle to which the tongue is detachably attached,
wherein the lap pretensioner includes:
a wire to be connected to the belt;
a sleeve-shaped cover covering the wire;
an actuator configured to pull the wire to pull the belt; and
a limiting member configured to limit a displacement of the cover, the limiting member extending inside the cover in a longitudinal direction of the cover.
